(19) United States
(12) Patent Application Publication
(10) Pub. No.: US 2005/0224012 A1
(43) Pub. Date: Oct. 13, 2005

(54) Nail trimming belt for pet exercise wheel

(76) Inventor: Karen McBride, Ontario (CA)

Correspondence Address: GOWLING, LAFLEUR HENDERSON LLP, ONE MAIN STREET WEST, HAMILTON, ON, L8P 4Z5, CA

(21) Appl. No.: 10/786,124

(22) Filed: Feb. 26, 2004

(51) Int. Cl. B24B 1/00

(52) U.S. Cl. 119/600

(57) ABSTRACT

A longitudinally extending nail trimming belt is adjustable in length and has a first outer layer of high friction slip resistant material. A layer of sandpaper is attached to the slip resistant layer and forms the second layer. Preferably, there is a third inner layer that has a plurality of spaced transversely extending rungs disposed over the sandpaper to expose selected areas of abrasive material.

### FIELD OF INVENTION

This invention relates to a belt which is associated with an exercise wheel of the kind used for giving exercise to small animals which are confined to small spaces such as a cage and kept as pets.

### BACKGROUND OF THE INVENTION

Many small animals which are kept as pets require extraordinary care because they reside in a confined environment which cannot provide the same conditions which would be found in their natural environment.

One of the problems which occurs is that nails are not worn down from natural abrasion. This problem can be addressed by clipping the nails. However, it is a task which often is very challenging to perform and a pet owner may have recourse to a professional groomer for assistance. Since nail growth does not stop, frequent, repeated visits to the groomer are required and this can become expensive and also inconvenient.

Owners of small pets have therefore resorted to using sandpaper as an abrasive for trimming the nails of their pets, the sandpaper having a very fine grit which will not cause injury to the paw pads of the animals. Conveniently, the sandpaper may be attached to the exterior surface of a pet exercise wheel which has an open mesh surface and which in use is gripped by the animal's paws. With the nails protruding through the mesh, the nails contact the abrasive and get trimmed while the animal runs on the interior of the wheel. In other cases, where the wheel has a closed running surface, strips of sandpaper are attached to the interior running surface using adhesive or clips. This has the disadvantage that the animal paws make contact with the abrasive surface of the sandpaper and this may injure the paws. Generally, it is not recommended that the animal be allowed to exercise on a wheel fitted with sandpaper for any prolonged period, exceeding two days, for example.

Another disadvantage is that the sandpaper must be trimmed to form a band having a circumference which is commensurate with the internal diameter of the exercise wheel. The attachment of the sandpaper is not always secure and the sandpaper can become dislodged and require replacement well before the recommended exercise period has expired. In some cases, pet owners choose to keep an exercise wheel which is fitted with an abrasive surface as a spare for use perhaps on a monthly basis while a regular wheel is provided for exercise during the rest of the month. This saves the pet owner the trouble of fitting the sandpaper onto and off the exercise wheel. However, if the paper becomes dislodged or damaged, even the spare exercise wheel must have the sandpaper replaced prematurely before the abrasive surface has been worn through use.

An object of this invention is to at least alleviate some of the aforementioned disadvantages.

### SUMMARY OF THE INVENTION

In accordance with this invention there is provided a longitudinally extending nail trimming belt which preferably is adjustable in length and which comprises a first outer layer of high friction slip resistant material and a second layer of abrasive material. Preferably, there is a third inner layer having a plurality of spaced transversely extending rungs disposed over the second layer to expose selected areas of abrasive material.

### BRIEF DESCRIPTION OF THE DRAWINGS

In order that the invention may be more clearly understood, a preferred embodiment will be described below with reference to the accompanying drawings, in which:

FIG. 1 is a schematic side elevation view of a preferred embodiment of a belt made in accordance with the invention and located in use on an exercise wheel;

FIG. 2 is a perspective view of the belt of FIG. 1 showing the belt according to the invention;

FIG. 3 is a side elevation view of the belt of FIG. 2;

FIG. 4 is a perspective view showing the belt being folded in an overlapping configuration;

FIG. 5 is a view showing overlapped ends of the belt and drawn to a larger scale; and

FIG. 6 is a cross-sectional view of a portion of the belt showing an animal paw engaging the belt.

### DESCRIPTION OF PREFERRED EMBODIMENT WITH REFERENCE TO DRAWINGS

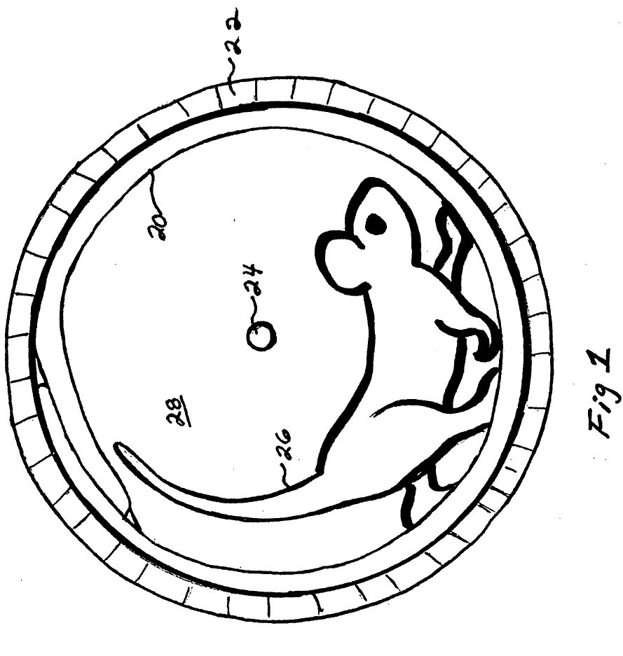

A nail trimming belt in accordance with the invention is generally designated by reference numeral 20 in FIG. 1 and is shown in association with an exercise wheel 2 pivoted for rotation about a central axle 24. A small marsupial affectionally known as a “Sugar Glider” is shown disposed inside the wheel with its paws contacting the belt 20. The Sugar Glider is identified by reference numeral 26 in the drawings. Sugar Gliders, in particular, are known to be very affectionate pets which will climb over their owner's body in order to obtain a better vantage point from which to explore their environment. One of the drawbacks of owning a Sugar Glider is that arms are often scratched by the small sharp nails of the Sugar Glider.

It will be appreciated that the exercise wheel 22 may take many forms. In the embodiment illustrated, the exercise wheel 22 is formed in the shape of an open drum having an interior cylindrical surface on which the Sugar Glider will run and a closed end surface 28 through which the axle 24 extends. The other end of the drum is open in order to allow the Sugar Glider 26 to enter and exit the exercise wheel 22. In some variations, the open end of the drum may be provided with a cover plate having entry and exit apertures for allowing the Sugar Glider to enter and leave the exercise wheel.

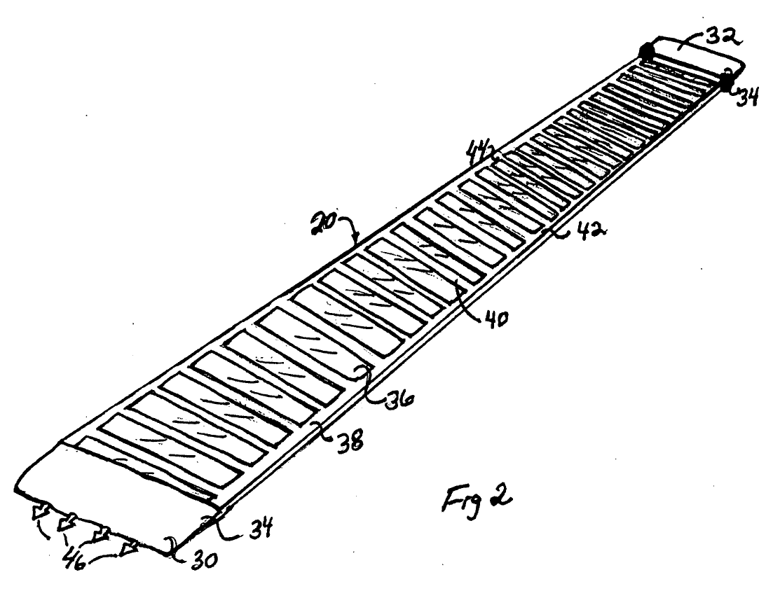

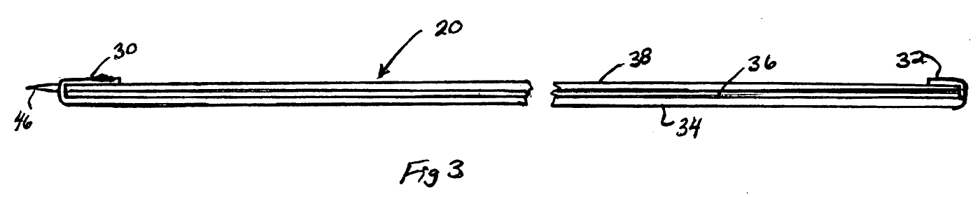

The construction of the nail trimming belt 20 is more clearly shown in FIG. 2 and in FIG. 3. It will be seen that the nail trimming belt 20 extends longitudinally between a first coupling end 30 and a second terminal end 32. The belt 20 is constructed in three layers consisting of an outer layer 34 of high friction, slip resistant material commonly available as a synthetic rubber-like sheet which is textured and resembles a woven fabric.

The outer layer 34, in use, is adapted to be placed on the interior cylindrical surface of the exercise wheel 22 and will adhere to the surface without the use of any additional adhesive, clips, or clamps.

An intermediate layer of abrasive material is disposed over the outer layer 34 and consists of a so-called wet/dry sandpaper having a very fine grit, for example at least 400 to 600 grit. An inner layer 38 is superposed over the intermediate layer 36 so as to sandwich the intermediate layer 36 between the inner layer 38 and the outer layer 34. The inner layer 38 is formed from synthetic plastic material and has a plurality of transversely extending rungs 40 which are disposed over the intermediate layer 36 and longitudinally spaced from each other to expose selected areas of abrasive material. In the embodiment shown, the rungs 40 are coupled to each other on the marginal edges of the belt by a pair of spaced parallel extending ribs 42, 44 so as to form a ladder-like configuration.

At the terminal end 32, the outer layer 34 is folded to lie over the intermediate layer 36 and the inner layer 38. Similarly, at the coupling end 30, the outer layer 34 is folded to lie over the inner layer 38 and the intermediate layer 36. The entire assembly is secured by stitching (not shown).

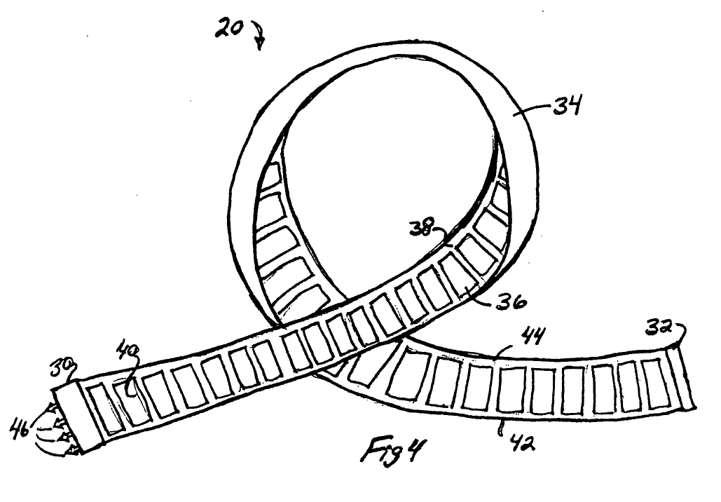

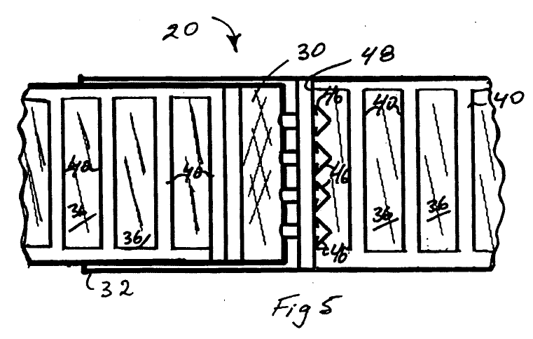

It will be noted that the coupling end 30 has a plurality of longitudinally extending darts 46 which extend a short distance from the marginal end of the belt 20 and which are adapted to engage a selected rung 40 as shown in FIG. 5 where the selected rung is identical by reference numeral 48. The rung 48 is selected according to the diameter of the exercise wheel 22 for which the nail trimming belt 20 is being fitted. It will be understood that the nail trimming belt 20 is folded in an overlapping configuration as illustrated by FIG. 4 in order to customize the belt to the exercise wheel for which it is being used since such wheels are available in a variety of diameters.

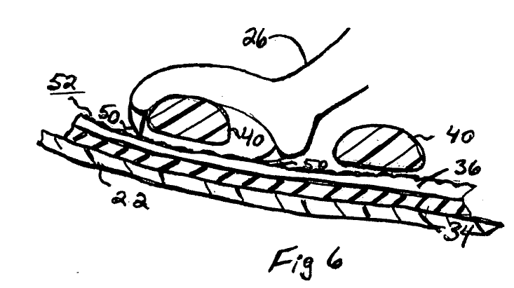

In use, the claw of a Sugar Glider 26, as shown in FIG. 6, will engage a rung 40 and its nails 50 will come into contact with the intermediate layer 36 so as to contact its abrasive surface 52. Every time the claw of the Sugar Glider is moved to grip another rung 40, the nails 50 engage the abrasive surface 52 and, in the process, are trimmed to a shorter, more desirable length thereby blunting their extremities and minimizing the likelihood of any injury to the pet owner. It is not recommended that the pet be allowed to exercise with an exercise wheel fitted with a nail trimming belt according to the invention for any prolonged periods of time. Once the recommended period of time has lapsed, the nail trimming belt is easily removed from the exercise wheel without any damage so that it can be reused, as necessary.

The invention thus provides a convenient device which is easily installed and adjusted to fit exercise wheels having a number of configurations and diameters. It will be understood that the high friction non-slip outer layer may be composed from alternative materials and could for example consist of a synthetic plastic layer having a smooth surface on one side and suction cups on the other. The intermediate layer is required to have an abrasive surface on an exposed side but the opposite side may, of course, be smooth. The nature of the abrasive and its grit distribution will be selected according to the sensitivity of the pet to contact with the abrasive. Finally, the inner layer may be selected to have a number of different configurations suitable for allowing the pet to climb on the internal surface of the exercise wheel. It will be understood that the rungs 40 serve both the function of allowing the paw to better grip the interior surface of the exercise wheel fitted with the nail trimming belt and also to shield the sensitive paw pad of the animal from contact with the abrasive surface. Depending on the nature of the animal, and the nature of the abrasive surface 52, it may be unnecessary to provide such rungs in the structure of the nail trimming belt. Several other variations may be made to the construction of the nail trimming belt as will be apparent to those skilled in the art. It will be understood that the above-described embodiment does not limit the scope of the protection afforded by the appended claims.

Other means may also be provided for securing the free coupling end 30 of the belt to another end of the belt in order to adjust the effective length of the nail trimming belt.

1. A nail trimming longitudinally extending belt having a first outer layer of high friction slip resistant material and a second layer of abrasive material secured to the first layer such that an abrasive surface is exposed on one side of the belt opposite from the first layer.

2. A nail trimming belt according to claim 1 in which the second layer consists of sandpaper.

3. A nail trimming belt according to claim 1 having a third inner layer disposed over the second layer and having a plurality of spaced transversely extending rungs which expose selected areas of abrasive material therebetween.

4. A nail trimming belt according to claim 1 having a free coupling end adapted to be releasably secured to the belt to form a loop of selected diameter.

5. A nail trimming belt and exercise wheel assembly consisting of a nail trimming belt having a first outer layer of high friction slip resistant material disposed on an interior cylindrical surface of an exercise wheel, the belt further having a second layer of abrasive material secured to the first layer such that an abrasive surface is exposed on an interior cylindrical surface of the assembly.

6. A nail trimming belt and exercise wheel assembly according to claim 5 in which the second layer consists of sandpaper.

7. A nail trimming belt and exercise wheel assembly according to claim 5 having a third inner layer disposed over the second layer and having a plurality of spaced transversely extending rungs which expose selected areas of abrasive material therebetween.

8. A nail trimming belt and exercise wheel assembly according to claim 5 having a free coupling end adapted to be releasably secured to the belt to form a loop of selected diameter commensurate with an internal diameter of the exercise wheel.
